(19) United States
(12) Patent Application Publication
(10) Pub. No.: US 2025/0008875 A1
(43) Pub. Date: Jan. 9, 2025

(54) NON-CONTACT SENSOR SYSTEMS FOR AN AGRICULTURAL HEADER

(71) Applicants: CNH Industrial America LLC, New Holland, PA (US); CNH INDUSTRIAL BELGIUM NV, Zedelgem (BE); CNH INDUSTRIAL HARBIN MACHINERY CO., LTD., Harbin, Anhui (CN)

(72) Inventors: Matthew D'Amicantonio, Jonestown, PA (US); Trevor D. Book, Lititz, PA (US); Cory Douglas Hunt, Millersville, PA (US); Bart M.A. Missotten, Herent (BE); Jethro Martin, Ephrata, PA (US); Pieter Van Overschelde, Sint-Andries (BE); Neseth Cora Kong, Leola, PA (US)

(21) Appl. No.: 18/707,319

(22) PCT Filed: Nov. 5, 2022
(86) PCT No.: PCT/US2022/049062

§ 371 Date: May 3, 2024

Related U.S. Application Data
(60) Provisional application No. 63/276,277, filed on Nov. 5, 2021.
(60) Provisional application No. 63/325,917, filed on Mar. 31, 2022.

(51) Int. Cl. A01D 41/14; A01D 41/127; A01D 57/02; A01D 75/18

(52) U.S. Cl. CPC A01D 41/141; A01D 41/127; A01D 57/02; A01D 75/18

(57) ABSTRACT

A sensor system (230) for an agricultural machine includes one or more first elements (232) configured to be supported by a reel member (220) that is configured to rotate relative to a frame (201) of the agricultural machine. The sensor system (230) also includes one or more second elements (231) configured to be supported by the frame (201) of the agricultural machine, wherein the one or more first elements (232) and the one or more second elements (231) are configured to interact to generate sensor feedback. The sensor system also includes a controller (290) configured to receive the sensor feedback, analyze the sensor feedback to identify occurrences of the reel member (220) being in an undesirable position relative to the frame (201) of the agricultural machine, and provide an output in response to the reel member (220) being in the undesirable position relative to the frame (201) of the agricultural machine.

### CROSS-REFERENCE TO RELATED APPLICATION

This application relates to U.S. Provisional Application No. 63/276,277, which was filed on Nov. 5, 2021, and is entitled “SYSTEMS AND METHODS FOR SETTING BOUNDARIES FOR A REEL OF AN AGRICULTURAL HEADER.”

### BACKGROUND

The present disclosure relates generally to non-contact sensor systems for an agricultural header.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A harvester may be used to harvest crops, such as barley, beans, beets, carrots, corn, cotton, flax, oats, potatoes, rye, soybeans, wheat, or other plants. A harvesting process may begin by operating a header of the harvester to remove a portion of a plant from a field. In some cases, the header may cut the plant to form cut crops and transport the cut crops to a processing system of the harvester.

Certain headers include a cutter bar assembly configured to cut a portion of each plant (e.g., a stalk), thereby separating the cut crops from the soil. The cutter bar assembly may extend along a substantial portion of a width of the header at a forward end of the header. The header may also include one or more belts positioned behind the cutter bar assembly relative to a direction of travel of the harvester. The belt(s) are configured to transport the cut crops to an inlet of the processing system.

Certain headers may also include a reel, which may include a reel member having multiple tines (e.g., fingers) extending from a central framework. The central framework is driven to rotate, such that the tines move in a circular pattern. The tines are configured to engage the plants, thereby preparing the plants to be cut by the cutter bar assembly and/or urging the cut crops to move toward the belt(s). The reel member is typically supported by multiple reel arms extending from a frame of the header. The reel may include one or more actuators configured to drive the multiple reel arms to rotate, thereby adjusting a position of the reel member relative to the frame of the header.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In an embodiment, a sensor system for an agricultural machine includes one or more first elements configured to be supported by a reel member that is configured to rotate relative to a frame of the agricultural machine. The sensor system also includes one or more second elements configured to be supported by the frame of the agricultural machine, wherein the one or more first elements and the one or more second elements are configured to interact to generate sensor feedback. The sensor system also includes a controller configured to receive the sensor feedback, analyze the sensor feedback to identify occurrences of the reel member being in an undesirable position relative to the frame of the agricultural machine, and provide an output in response to the reel member being in the undesirable position relative to the frame of the agricultural machine.

In an embodiment, an agricultural machine includes a frame. The agricultural machine also includes a reel member having a central framework and multiple tines coupled to the central frame work. The agricultural machine also includes one or more sensors disposed on the frame or the reel member, wherein the one or more sensors are configured to detect one or more detectable elements disposed on the agricultural machine and to generate sensor feedback indicative of occurrences of the reel member being in an undesirable position relative to the frame.

In an embodiment, a method of operating an agricultural machine includes detecting, using one or more sensors, a detectable element disposed on a reel member or a frame of the agricultural machine. The method also includes receiving, at a controller, sensor feedback from the one or more sensors, wherein the sensor feedback is indicative of occurrences of the reel member being in an undesirable position relative to the frame of the agricultural machine. The method also includes controlling, using the controller, one or more actuators to move at least a portion of the reel member away from the frame of the agricultural machine in response to the reel member being in the undesirable position relative to the frame of the agricultural machine.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an agricultural system, in accordance with an embodiment of the present disclosure;

FIG. 2 is a perspective view of a header and a sensor system that may be employed within the agricultural system of FIG. 1, in accordance with an embodiment of the present disclosure;

FIG. 3 is a cross-sectional side view of the header and the sensor system of FIG. 2, in accordance with an embodiment of the present disclosure;

FIG. 4 is a perspective view of a portion of the header and the sensor system of FIG. 2, wherein the sensor system includes a detectable element on a cutter bar assembly, in accordance with embodiment of the present disclosure;

FIG. 5 is a cross-sectional side view of a header and a sensor system that may be employed within the agricultural system of FIG. 1, wherein the sensor system includes a detectable element on a tine of a reel, in accordance with an embodiment of the present disclosure;

FIG. 6 is an example of a graph that illustrates a skew in a magnetic field that may be detected by multiple sensors positioned on a header that may be employed within the agricultural system of FIG. 1, in accordance with an embodiment of the present disclosure; and

FIG. 7 is a flow diagram of a method of operating a header and a sensor system of an agricultural system, in accordance with an embodiment of the present disclosure.

### DETAILED DESCRIPTION

One or more of the specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The process of farming typically begins with planting seeds within a field. Over time, the seeds grow and eventually become harvestable crops. Often, only a portion of each crop is commercially valuable, so each crop is harvested to separate the usable material from the remainder of the crop. For example, a harvester may cut crops within a field via a header, which may include a flexible draper header. The header may include a cutter bar assembly configured to cut the crops. As the cutter bar assembly cuts the crops, a conveyor coupled to draper deck(s) of the header moves the cut crops toward a crop processing system of the harvester. For example, the conveyor on the side draper deck(s) may move the cut crops toward an infeed draper deck at a center of the header. A conveyor on the infeed draper deck may then move the cut crops toward the crop processing system. The crop processing system may include a threshing machine configured to thresh the cut crops, thereby separating the cut crops into certain desired agricultural materials, such as grain, and material other than grain (MOG). The desired agricultural materials may be sifted and then accumulated into a tank. When the tank fills to capacity, the desired agricultural materials may be collected from the tank. The MOG may be discarded from the harvester (e.g., via a spreader) by passing through an exit pipe or a spreader to fall down onto the field.

In some embodiments, portions of the cutter bar assembly may move so as to follow a contour of the field. For example, the cutter bar assembly may be flexible to remain in contact with the field during harvesting operations. Furthermore, the header of the harvester includes a reel (e.g., reel assembly) configured to prepare the crops to be cut by the cutter bar assembly. As an example, the reel may be positioned adjacent to the cutter bar assembly and may be configured to guide the crops toward the cutter bar assembly to facilitate cutting the crops. The position of the reel is adjustable relative to the cutter bar assembly so as to enable the reel to effectively guide the crops toward the cutter bar assembly. However, in some circumstances, the cutter bar assembly and the reel may interfere with one another. For instance, the cutter bar assembly may contact part of the reel, thereby limiting an effectiveness of the cutter bar assembly, the reel, and the header.

It is now recognized that detecting, monitoring, and/or responding to a position of the reel relative to the cutter bar assembly may improve operation of the header. More particularly, it is now recognized that detecting, monitoring, and/or responding to a distance between the reel and the cutter bar assembly may improve operation of the header. To facilitate these techniques, the header may utilize a sensor system. In some embodiments, the sensor system includes a detectable element (e.g., feature, component, emitter, optical marker, radiofrequency identification [RFID] tag, metal object, magnet) and a sensor (e.g., detector, receiver, sensor, camera, RFID reader, metal sensor, magnetic sensor, capacitance sensor) that is configured to detect the detectable element. For example, the detectable element may be an acoustic emitter that is configured to emit acoustic waves, and the sensor may be an acoustic sensor that is configured to detect the acoustic waves. In some embodiments, the detectable element may be disposed at the cutter bar assembly, and the sensor may be disposed at the reel (e.g., at a reel bat of the reel). However, in some embodiments, the sensor may be disposed at the cutter bar assembly, and the detectable element may be disposed at the reel (e.g., a tine of the reel). Additional configurations and variations of the sensor system are discussed herein.

In any case, the sensor may generate sensor signals (e.g. sensor feedback or data) indicative of the distance between the reel and the cutter bar assembly. A controller (e.g., electronic controller) may receive the sensor signals, process the sensor signals to determine the distance, and then compare the distance to a threshold distance. The controller may also provide one or more outputs in response to the distance being less than the threshold distance. The one or more outputs may include a retract control signal to move the tine of the reel away from the knife of the cutter bar assembly (e.g., to raise/lower the reel; to move the tine relative to a central framework of the reel), a block control signal to block and/or to slow further movement of the tine of the reel toward the knife of the cutter bar assembly, and/or an alert (e.g., visible and/or audible alert) to an operator. The controller may further provide one or more outputs in response to the distance being greater than the threshold distance, such as one or more outputs to notify the operator that the reel is in an acceptable or desirable position relative to the cutter bar assembly.

In some embodiments, the sensor system is a non-contact sensor system that enables detection of the distance being within the threshold distance even without contact between the reel and the cutter bar assembly. Furthermore, the threshold distance may be set to any suitable distance, such as 0.5, 1, 2, 3, 4, 5, 6, 7, 8, 9, 10 or more centimeters (cm). The threshold distance may be established for each header (e.g., specific to each header) based on the sensor signals collected during operation of the header, or the threshold distance may be established for multiple headers with shared characteristics at manufacturing.

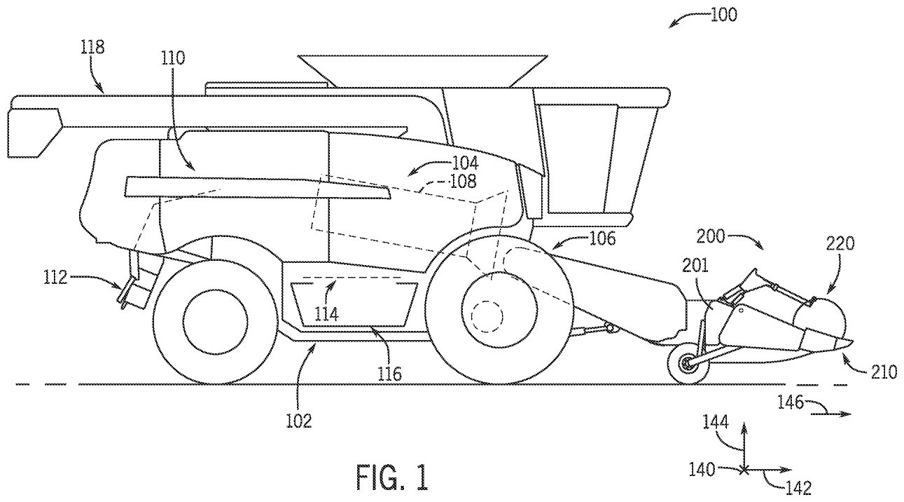

With the foregoing in mind, FIG. 1 is a side view of an embodiment of an agricultural system 100, which may be a harvester. The agricultural system 100 includes a chassis 102 configured to support a header 200 and an agricultural crop processing system 104. The header 200 is configured to cut crops and to transport the cut crops toward an inlet 106 of the agricultural crop processing system 104 for further processing of the cut crops.

The agricultural crop processing system 104 receives the cut crops from the header 200 and separates desired crop material from crop residue. For example, the agricultural crop processing system 104 may include a thresher 108 having a cylindrical threshing rotor that transports the cut crops in a helical flow path through the agricultural system 100. The thresher 108 may also separate the desired crop material (e.g., grain) from the crop residue (e.g., husks and pods), and the thresher 108 may enable the desired crop material to flow into a cleaning system 114 located beneath the thresher 108.

The cleaning system 114 may remove debris from the desired crop material and transport the desired crop material to a storage tank 116 within the agricultural system 100. When the storage tank 116 is full, a tractor with a trailer on the back may pull alongside the agricultural system 100. The desired crop material collected in the storage tank 116 may be carried up by an elevator and dumped out of an unloader 118 into the trailer. The crop residue may be transported from the thresher 108 to a crop residue handling system 110, which may process (e.g., chop/shred) and remove the crop residue from the agricultural system 100 via a crop residue spreading system 112 positioned at an aft end of the agricultural system 100. To facilitate discussion, the agricultural system 100 and/or its components may be described with reference to a lateral axis or direction 140, a longitudinal axis or direction 142, and a vertical axis or direction 144. The agricultural system 100 and/or its components may also be described with reference to a direction of travel 146 (e.g., forward direction of travel).

The header 200 includes a cutter bar assembly 210 configured to cut the crops within the field. The header 200 also includes a reel 220 (e.g., reel assembly) configured to engage the crops to prepare the crops to be cut by the cutter bar assembly 210 and/or to urge the crops cut by the cutter bar assembly 210 onto a conveyor system that directs the cut crops toward the inlet 106 of the agricultural crop processing system 104. The reel 220 includes a reel member having multiple tines (e.g., fingers) extending from a central framework. The central framework is driven to rotate such that the tines engage the crops and urge the crops toward the cutter bar assembly 210 and the conveyor system. Additionally, the reel members may be slidingly supported on multiple arms (e.g., reel arms) that are coupled to a frame 201 of the header 200. Furthermore, each of the arms may be coupled to the frame 201 via a respective pivot joint. For example, one pivot joint is configured to enable a first arm of the multiple arms to pivot (e.g., about the lateral axis 140) relative to the frame 201, and another pivot joint is configured to enable a second arm of the multiple arms to pivot (e.g., about the lateral axis 140) relative to the frame 201.

It should be appreciated the header 200 with the cutter bar assembly 210 and/or the reel 220 may be employed in any suitable type of harvester or similar agricultural machine (e.g., swathers/windrowers that gather the cut crops to form a windrow in the field that is later collected by the harvester). Furthermore, the reel 220 may be operated to move relative to a frame or any portion of a frame of any suitable type of harvester or similar agricultural machine (e.g., the reel 220 may be considered to move relative to the frame or any portion of the frame; the cutter bar assembly 210 described herein may be considered to be part of the frame).

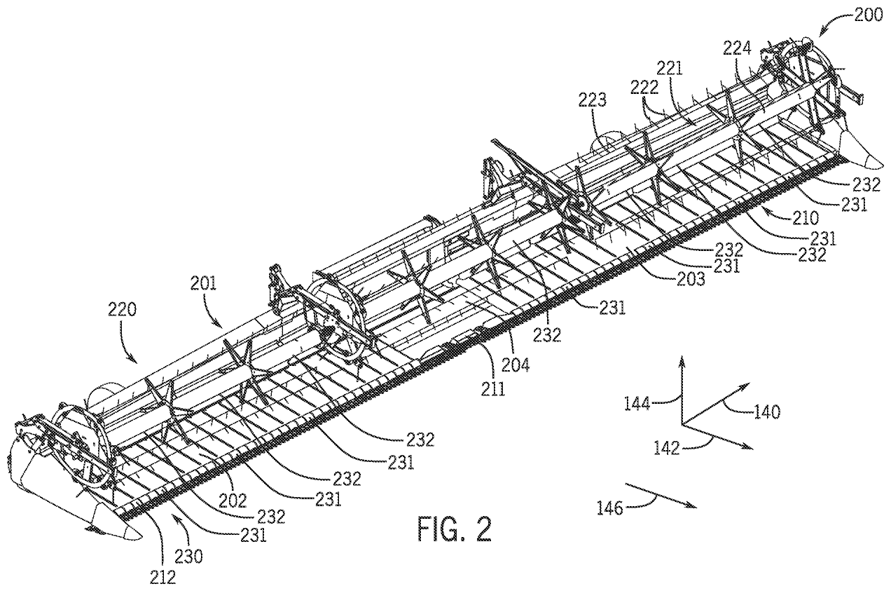

FIG. 2 is a perspective view of an embodiment of the header 200. In the illustrated embodiment, the header 200 includes the cutter bar assembly 210 configured to cut a portion of each crop (e.g., a stalk), thereby separating the crop from the soil. The cutter bar assembly 210 is positioned at a forward end of the header 200 relative to the longitudinal axis 142 of the header 200. As illustrated, the cutter bar assembly 210 extends along a substantial portion of the width of the header 200 (e.g., along the lateral axis 140).

The cutter bar assembly 210 includes a blade support, a stationary guard assembly, and a moving blade assembly (e.g., knife). The moving blade assembly is fixed to the blade support (e.g., above the blade support along the vertical axis 144 of the header 200), and the blade support/moving blade assembly is driven to oscillate relative to the stationary guard assembly. The blade support/moving blade assembly may be driven to oscillate by a driving mechanism 211 positioned at a center of the header 200. However, in other embodiments, the blade support/moving blade assembly may be driven by another suitable mechanism (e.g., located at any suitable position on the header 200). As the agricultural system 100 is driven through the field, the cutter bar assembly 210 engages crops within the field, and the moving blade assembly cuts the crops (e.g., the stalks of the crops) in response to engagement of the cutter bar assembly 210 with the crops.

In the illustrated embodiment, the header 200 includes a first conveyor section 202 on a first lateral side of the header 200 and a second conveyor section 203 on a second lateral side of the header 200 opposite the first lateral side. The first conveyor section 202 may extend along a portion of a width of the header 200 and the second conveyor section 203 may extend along another portion of the width of the header 200. Each conveyor section 202, 203 is driven to rotate by a suitable drive mechanism, such as an electric motor or a hydraulic motor. The first conveyor section 202 and the second conveyor section 203 are driven such that a top surface of each conveyor section 202, 203 moves laterally inward to a center conveyor section 204 positioned between the first conveyor section 202 and the second conveyor section 203 along the lateral axis 140. The center conveyor section 204 may also be driven to rotate by a suitable drive mechanism, such as an electric motor or a hydraulic motor. The center conveyor section 204 is driven such that the top surface of the center conveyor section 204 moves rearwardly relative to the direction of travel 146 toward the inlet. As a result, the conveyor sections 202, 203, 204 transport the cut crops through the inlet to the agricultural crop processing system for further processing of the cut crops. Although the illustrated header 200 includes two conveyor sections 202, 203 configured to direct crops toward the center conveyor section 204, there may be any suitable number of conveyor sections in additional or alternative embodiments directing the crops toward the center conveyor section.

The crops cut by the cutter bar assembly 210 are directed toward the conveyor sections 202, 203, 204 at least in part by the reel 220, thereby substantially reducing the possibility of the cut crops falling onto the surface of the field. The reel 220 includes a reel member 221 having multiple fingers or tines 222 extending from a central framework 223. The central framework 223 is driven to rotate such that the tines 222 move (e.g., in a circular pattern; about the lateral axis 140). The tines 222 are configured to engage the crops and urge the cut crops toward the conveyor sections 202, 203 to facilitate transport of the cut crops to the agricultural crop processing system.

In some embodiments, the frame 201 of the header 200 may be movably coupled to the chassis of the agricultural system. As illustrated herein, the cutter bar assembly 210 is flexible along the width of the header 200. In particular, the cutter bar assembly 210 is supported by multiple arm assemblies distributed along the width of the header 200. Each arm assembly is mounted to the frame 201 and includes an arm coupled to the cutter bar assembly 210. The arm may rotate and/or move the cutter bar assembly 210 along the vertical axis 144 relative to the frame 201, thereby enabling the cutter bar assembly 210 to flex during operation of the agricultural system. Thus, the cutter bar assembly 210 may follow the contours of the field, thereby enabling the cutting height (e.g., the height at which each crop is cut) to be substantially constant along the width of the header 200.

The header 200 also includes a sensor system 230, which may include one or more detectable elements 231 (e.g., feature, component, emitter, optical marker, radiofrequency identification [RFID] tag, metal object, magnet) and one or more sensors 232 (e.g., detector, receiver, sensor, camera, RFID reader, metal sensor, magnetic sensor, capacitance sensor). The one or more sensors 232 are configured to detect the one or more detectable elements 231 and generate sensor signals (e.g., sensor feedback or data) indicative of a distance between the cutter bar assembly 210 and the reel 220. To facilitate discussion, the one or more detectable elements 231 are shown on a crop ramp 212 of the cutter bar assembly 210, and the one or more sensors 232 are shown on a reel bat 224 (e.g., cylindrical member or tube) of the central framework 223 of the reel 220. However, additional configurations and variations of the sensor system 230 are envisioned.

In some embodiments, the one or more detectable elements 231 may include multiple detectable elements 231 and/or the one or more sensors 232 may include multiple sensors 232 across the width of the header 200, such as multiple detectable elements 231 across the cutter bar assembly 210 and/or multiple sensors 232 across the reel 220. This may be advantageous because portions of the cutter bar assembly 210 may flex in different ways or to different degrees based on features in the field. Additionally, certain headers 200 may enable sectional control of the reel 220 (e.g., to raise only a left side portion of the reel 220 if a respective distance along the left side portion is below a threshold distance, but a respective distance along a center portion of the reel 220 is above the threshold distance). Regardless of the number of detectable elements 231 and sensors 232, each of the one or more detectable elements 231 may be generally aligned with (e.g., along the lateral axis 140) and/or positioned to interact with (e.g., be detected by) at least one of the one or more sensors 232.

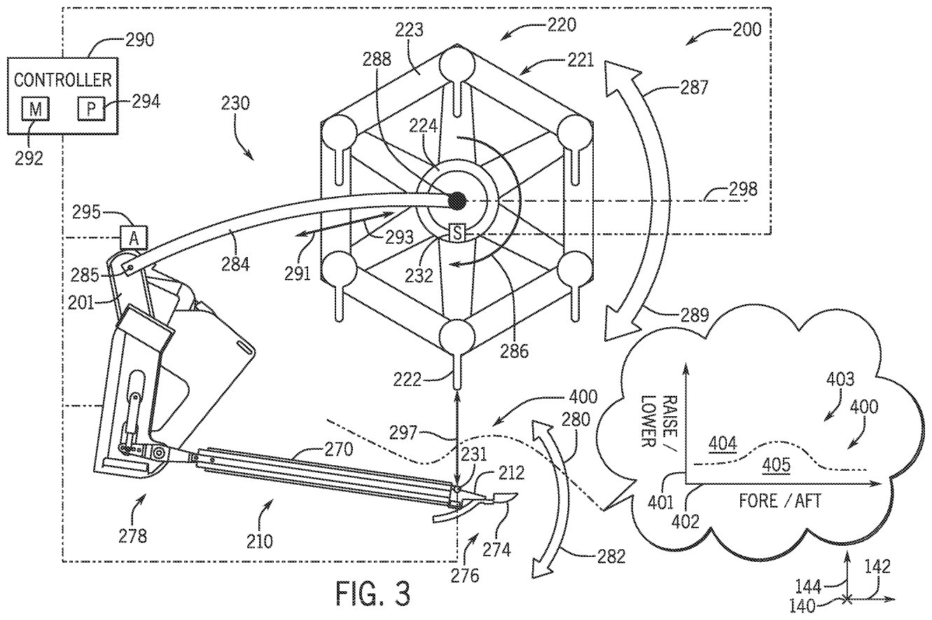

FIG. 3 is a cross-sectional side view of an embodiment of the header 200. As shown, the cutter bar assembly 210 includes arms 270 supporting blades 274 (e.g., knife) at a first end 276 of the arms 270. The cutter bar assembly 210 also includes the crop ramp 212 between the arms 270 and the blades 274. Further, the arms 270 may be coupled to the frame 201 of the header 200 at a second end 278 of the arms 270. As an example, the arms 270 may be pivotably coupled to the frame 201 at the second end 278. In this manner, the arms 270 may be configured to rotate relative to the frame 201. As such, the arms 270 may rotate in a first rotational direction 280 (e.g., upward), which may raise the arms 270 along the vertical axis 144, and the arms 270 may rotate in a second rotational direction 282 (e.g., downward), which may lower the arms 270 along the vertical axis 144.

In certain embodiments, the arms 270 may freely rotate in the rotational directions 280, 282 to follow a contour of the field. For example, the arms 270 may position the blades 274 to maintain contact with the field. As such, an upward slope of the field may push the arms 270 to rotate in the first rotational direction 280 to raise the blades 274 relative to the frame 201 and therefore avoid inserting the blades 274 into the field. Moreover, at a downward slope of the field, the weight of the blades 274 may cause the arms 270 to rotate in the second rotational direction 282 to lower the blades 274 relative to the frame 201 such that the blades 274 remain in contact with the field. In additional or alternative embodiments, the entire cutter bar assembly may translate along the vertical axis. That is, in addition to or as an alternative to rotating about the frame, the cutter bar assembly may slide along the frame in the vertical direction. Indeed, the cutter bar assembly 210 may be configured to move in any suitable manner relative to the frame 201 to enable the blades 274 to maintain contact with and/or to generally follow along contours of the field as the header 200 travels through the field.

The reel 220 may also move relative to the frame 201 and relative to the cutter bar assembly 210. In the illustrated embodiment, the frame 201 includes or is coupled to an extension 284 (e.g., a reel arm), which couples the reel member 221 (which includes the central framework 223 having the reel bat 224, as well as the tines 222 supported on the central framework 223) to the frame 201. The extension 284 may position the reel member 221 above the cutter bar assembly 210 along the vertical axis 144 such that the reel 220 may urge the cut crops toward the blades 274. For instance, the reel member 221 may rotate in a third rotational direction 286 about a pivot point 288 that couples the reel member 221 to the extension 284. By rotating in the third rotational direction 286, the tines 222 may guide the crops toward the blades 274 that cut the crops.

The extension 284 may also move relative to the frame 201 to move the reel 220 relative to the frame 201 and relative to the cutter bar assembly 210. As an example, the extension 284 may rotate about a pivot point 285 that couples the extension 284 to the frame 201. Thus, the extension 284 may rotate about the frame 201 and may be configured to raise the reel 220 in a first rotational direction 287 (e.g., upward) relative to the vertical axis 144 and/or in a second rotational direction 289 relative to the vertical axis 144 (e.g., downward). In this way, the extension 284 may be positioned desirably relative to the cutter bar assembly 210 to enable the reel 220 to guide the crops to be cut by the cutter bar assembly 210. In an example, the reel 220 may be positioned proximate to the cutter bar assembly 210 without the tines 222 interfering (e.g., contacting) with the blades 274.

The reel member 221 may also be configured to slide (e.g., fore/aft) relative to the extension 284. For example, the reel member 221 may slide in a rearward direction 291 and a forward direction 293 along the extension 284. In additional or alternative embodiments, the entire reel may translate along the vertical axis. That is, in addition to or as an alternative to rotating about the frame, the reel may slide along the frame in the vertical direction. Indeed, the reel may be configured to move in any suitable manner relative to the frame 201 to enable the tines 222 to capture and/or direct the crops as the header 200 travels through the field.

As shown, the header 200 includes and/or is communicatively coupled to a controller 290 (e.g., electronic controller; computing system) configured to perform calculations and/or control operating parameters of at least portions of the agricultural system, such as of the header 200. The controller 290 may include a memory 292 and a processor 294 (e.g., a microprocessor). The controller 290 may also include one or more storage devices and/or other suitable components. The processor 294 may be used to execute software, such as software for processing sensor feedback, generating one or more boundaries, and/or controlling the agricultural system and/or the header 200. Because the controller 290 may control various components of the agricultural system, the controller 290 may be considered to be part of the agricultural system, the header 200 or other machine, the sensor system 230, or any of the assemblies or systems (e.g., part of the cutter bar assembly 210, the reel 220) of the agricultural system.

Moreover, the processor 294 may include multiple microprocessors, one or more “general-purpose” microprocessors, one or more special-purpose microprocessors, and/or one or more application specific integrated circuits (ASICS), or some combination thereof. For example, the processor 294 may include one or more reduced instruction set (RISC) or complex instruction set (CISC) processors. The memory 292 may include a volatile memory, such as random access memory (RAM), and/or a nonvolatile memory, such as read-only memory (ROM). The memory 292 may store a variety of information and may be used for various purposes. For example, the memory 292 may store processor-executable instructions (e.g., firmware or software) for the processor 294 to execute, such as instructions for processing sensor signals and/or controlling the agricultural system. The memory 292 and/or the processor 294, or an additional memory and/or processor, may be located in any suitable portion of the agricultural system. By way of example, the controller 290 may be located in a cab of the agricultural system and/or on the header 200.

As shown, the header 200 may include one or more actuators 295 and the sensor system 230. The one or more actuators 295 may be configured to move the extension 284 relative to the frame 201 to move (e.g., rotate) the reel 220 up and down relative to the frame 201 and relative to the cutter bar assembly 210. The one or more actuators 295 may also be configured to move the reel member 221 fore and aft along the extension 284 to move (e.g., slide) the reel member 221 relative to the frame 201 and relative to the cutter bar assembly 210. In some embodiments, the one or more actuators 295 may be configured to move (e.g., rotate) the tines 222 relative to the central framework 223 of the reel 220.

In FIG. 3, the one or more detectable elements 231 are disposed on the cutter bar assembly 210. Although one detectable element 231 is shown at the crop ramp 212 of the cutter bar assembly 210 to represent a presence of the one or more detectable elements 231 on the cutter bar assembly 210, it should be appreciated that any number of detectable elements 231 may be placed at any of a variety of locations of the cutter bar assembly 210 (e.g., along the arms 270). Additionally, in FIG. 3, the one or more sensors 232 are disposed on the reel 220. Although one sensor 232 is shown at the reel bat 224 to represent a presence of the one or more sensors 232 on the reel 220, it should be appreciated that any number of sensor 232 may be placed at any of a variety of locations of the reel 220 (e.g., on the extension 284; on one or more of the tines 222). As shown and described with reference to FIG. 2, multiple detectable elements 231 and/or multiple sensors 232 may be spaced apart (e.g., distributed) across the width of the header 200 (e.g., along the lateral axis 140).

In operation, the sensor 232 may detect the detectable element 231 and generate the sensor signals that indicate a relative position of the reel 220 and the cutter bar assembly 210. The sensor signals are provided to the controller 290 and enable the controller 290 to identify that the reel 220 is in an undesirable position relative to the cutter bar assembly 210 (e.g., the distance 297 is within a threshold distance of the cutter bar assembly 210, which may refer to being in proximity of the cutter bar assembly 210 and/or in contact with the cutter bar assembly 210). While the distance 297 is illustrated between the tines 222 of the reel 220 and the arm 270 of the cutter bar assembly 210 to facilitate discussion, it should be appreciated that the distance 297 may be a measured distance between the detectable element 231 and the sensor 232 or a calculated distance between any suitable portions of the reel 220 and the cutter bar assembly 210 (e.g., a distal end of the tine 222 of the reel 220 and the blades 274 of the cutter bar assembly 210) based on known or stored relationships (e.g., location of the detectable element 231 on the cutter bar assembly 210 relative to the blades 274; location of the sensor 232 on the reel 220 relative to a distal end of the tine 222).

The sensor system 230 may be configured to detect each instance or event (e.g., occurrence) in which detectable element 231 passes within a range of the sensor 232. The range of the sensor 232 may be set to correspond to the threshold distance, such that each detection of the detectable element 231 is considered to indicate that the distance 297 is within the threshold distance. Thus, each detection of the detectable element 231 may result in the controller 290 providing the one or more outputs (e.g., moving the tine 222 away from the cutter bar assembly 210). However, in some embodiments, each sensor 232 may provide the sensor signals that indicate the distance 297 between the reel 220 and the cutter bar assembly 210. Then, the controller 290 may process the sensor signals to calculate the distance 297, compare the distance to the threshold distance, and provide the one or more outputs in response to the distance being within the threshold distance.

In any case, each time the reel 220 is within the threshold distance of the cutter bar assembly 210 or otherwise in an undesirable position relative to the cutter bar assembly 210, the controller 290 may provide the one or more outputs. For example, the controller 290 may respond by controlling the one or more actuators 295 to move the reel 220 or a portion of the reel 220 (e.g., the tines 222) away from the cutter bar assembly 210 (e.g., to move the reel 220 in the first rotational direction 287; to move the tines 222 relative to the central framework 223). Additionally or alternatively, the controller 290 may respond by slowing or blocking further movement of the reel 220 toward the cutter bar assembly 210. Additionally or alternatively, the controller 290 may respond by providing an alert to the operator.

In some embodiments, the sensor system 230 may be a non-contact sensor system that enables detection of the distance 297 even without contact between the reel 220 and the cutter bar assembly 210. Furthermore, the threshold distance may be set to any suitable distance, such as 0.5, 1, 2, 3, 4, 5, 6, 7, 8, 9, 10, or more cm. In some embodiments, the threshold distance may essentially be zero, such that the one or more sensors 232 detect when the reel 220 contacts the cutter bar assembly 210. The threshold distance may be established for each header (e.g., specific to each header) based on the sensor signals collected during operation of the header, or the threshold distance may be established for multiple headers with shared characteristics at manufacturing.

It should be appreciated that the one or more detectable elements 231 and the one or more sensors 232 may swap or exchange positions, such that the one or more detectable elements 231 are located on the reel 220 (e.g., at the reel bat 224 of the reel 220) and the one or more sensors 232 are located on the cutter bar assembly 210 (e.g., the crop ramp 212 of the cutter bar assembly 210). In certain embodiments, the one or more detectable elements 231 and/or the one or more sensors 232 at the reel 220 (e.g., at the reel bat 224 of the reel 220) may be supported so as not to rotate with the reel member 221 of the reel 220 (e.g., suspended to hang generally downward from the reel bat 224 of the reel 220 along the vertical axis 140; coupled to a structure that moves up/down and fore/aft with the reel bat 224, but does not rotate in the third rotational direction 286 with the reel bat 224 of the reel 220).

FIG. 3 also illustrates an example of a boundary 400 that may be generated and/or used for the reel 220 of the header 200. As shown, the boundary 400 is multi-dimensional (e.g., two-dimensional) and may be defined with respect to a raise/lower axis 401 and a fore/aft axis 402. As shown, the raise/lower axis 401 and the fore/aft axis 402 may be represented along a y-axis and a x-axis, respectively, in a graph 403. The controller 290 may be configured to enable movement of the reel 220 on an upper side 404 (e.g., above; opposite the cutter bar assembly 210) of the boundary 400 and to block or to slow the reel 220 from being positioned on a lower side 405 (e.g., below; toward the cutter bar assembly 210) the boundary 400. The controller 290 may block the reel 220 from being positioned on the lower side 405 simply by blocking certain movements of the reel 220 (e.g., downward); however, it should be appreciated that this may also be accomplished by initiating certain movements of the reel 220 (e.g., upward). In some cases, the controller may be configured to limit (e.g., slow; small increments) movement of the reel 220 on the lower side 405 of the boundary 400.

Thus, the operator may provide inputs via the user interface to adjust the reel 220 in the first rotational direction 287 (e.g., upward) and/or in the second rotational direction 289 (e.g., downward), as well as in in the rearward direction 291 and the forward direction 293 along the extension 284. In some embodiments, the controller 290 may monitor the distance 297 between the reel 220 and the cutter bar assembly 210, and the controller 290 may use the sensor signals indicative of the distance 297 between the reel 220 and the cutter bar assembly 210 to update the boundary 400.

For example, the header 200 may begin with a default boundary that is established based on modeled data, empirical data from multiple other headers, and/or header-specific data collected during trial operation of the header 200 in a field or manufacturing facility. Then, the boundary 400 may be updated based on the sensor signals from the sensors 232. For example, the sensor signals indicate each occurrence of the reel 220 being within the threshold distance of the cutter bar assembly 210 (e.g., due to the cutter bar assembly 210 pivoting/flexing as the header 200 travels across the field). The controller 290 may process the sensor signals to update the boundary 400, such as to raise the boundary 400 at a particular fore/aft position if the reel 220 is ever or repeatedly within the threshold distance of the cutter bar assembly 210 at the particular fore/aft position along the boundary 400. In this way, the sensor system 230 may enable dynamic, header-specific boundaries to guide or to limit movement of the reel 220, for example.

The one or more detectable elements 231 and the one or more sensors 232 may be any of a variety of types of elements and/or sensors, respectively, that enable the sensor system 230 to perform the disclosed techniques. In some embodiments, the one or more detectable elements 231 are acoustic emitters, and the one or more sensors 232 are acoustic sensors. Thus, the one or more detectable elements 231 emit acoustic waves that are detected by the one or more sensors 232. The one or more sensors 232 generate the sensor signals that indicate, via a time of flight of the acoustic waves, the distance 297 between the cutter bar assembly 210 and the reel 220. In such cases, the controller 290 may control timing of the emission of the acoustic waves by each of the one or more detectable elements 231 and also receive a timestamp of the detection of the acoustic waves by each of the one or more sensors 232 to enable the controller to determine the time of flight of the acoustic waves and the distance 297 between the cutter bar assembly 210 and the reel 220.

In some embodiments, the one or more sensors 232 may be acoustic transducers that emit and detect acoustic waves. In such cases, each sensor 232 may emit acoustic waves, then the acoustic waves may be reflected by one or more structures (e.g., of the cutter bar assembly 210), and then the acoustic waves may be detected by the sensor 232. Thus, the one or more structures may act as or be the one or more detectable elements 231. The one or more sensors 232 may generate the sensor signals that indicate, via a time of flight of the acoustic waves, the distance 297 between the cutter bar assembly 210 and the reel 220. In some embodiments, each of the one or more structures may have a feature (e.g., a curvature, a flat surface, a textured surface, a shape) that causes a detectable signature (e.g., one or more characteristics) in the acoustic waves that are reflected by the one or more structures. Thus, the detectable signature in the acoustic waves may be detected by the sensor 232 and may be indicated in the sensor signals received by the controller 290. Accordingly, the detectable signature in the acoustic waves may enable the controller 290 to more accurately isolate and identify the acoustic waves reflected by the one or more structures, as well as determine the time of flight of the acoustic waves to derive the distance 297 between the cutter bar assembly 210 and the reel 220. As noted herein, the one or more detectable elements 231 and the one or more sensors 232 may swap or exchange positions.

In some embodiments, the one or more detectable elements 231 are light emitters, and the one or more sensors 232 are light sensors (e.g., optical sensors). Thus, the one or more detectable elements 231 emit light that is detected by the one or more sensors 232. The one or more sensors 232 generate the sensor signals that indicate, via a time of flight of the light, the distance 297 between the cutter bar assembly 210 and the reel 220. In such cases, the controller 290 may control timing of the emission of the light by each of the one or more detectable elements 231 and also receive a timestamp of the detection of the light by each of the one or more sensors 232 to enable the controller to determine the time of flight of the light and the distance 297 between the cutter bar assembly 210 and the reel 220.

In some embodiments, the one or more sensors 232 may be light transducers that emit and detect light. In such cases, each sensor 232 may emit light, then the light may be reflected by one or more structures (e.g., of the cutter bar assembly 210), and then the light may be detected by the sensor 232. Thus, the one or more structures may act as or be the one or more detectable elements 231. The one or more sensors 232 may then generate the sensor signals that indicate, via a time of flight of the light, the distance 297 between the cutter bar assembly 210 and the reel 220. In some embodiments, each of the one or more structures may have a feature (e.g., a reflector, a curvature, a flat surface, a textured surface, a shape) that causes a detectable signature in the light that is reflected by the one or more structures. Thus, the detectable signature in the light may be detected by the sensor 232 and may be indicated in the sensor signals received by the controller 290. Accordingly, the detectable signature in the light may enable the controller 290 to more accurately isolate and identify the light reflected by the structure, as well as determine the time of flight of the light to derive the distance 297 between the cutter bar assembly 210 and the reel 220. As noted herein, the one or more detectable elements 231 and the one or more sensors 232 may swap or exchange positions. It should also be appreciated that these techniques may be implemented with any suitable type of electromagnetic wave or radiation (e.g., emitter and detector pairs or transducers; based on time of flight).

More specifically, in some embodiments, the one or more detectable elements 231 are radiofrequency identification (RFID) tags, and the one or more sensors 232 are RFID readers. Thus, the one or more detectable elements 231 actively (e.g., periodically) and/or passively (e.g., in response to receipt of electromagnetic radiation from the RFID reader) transmit a unique identifier to the RFID readers. In some cases, the RFID tags and the RFID readers may be selected to have a communication range that corresponds to the threshold distance. Thus, each instance of successful communication between the RFID tags and the RFID readers (e.g., each time the RFID readers receive the unique identifier from the RFID tags) indicates that the reel 220 is in an undesirable position relative to the cutter bar assembly 210 (e.g., within the threshold distance of the cutter bar assembly 210). In some cases, the RFID reader may detect a signal strength from the RFID tag, and the controller 290 may analyze the signal strength to calculate the distance 297 between the cutter bar assembly 210 and the reel 220. As noted herein, the one or more detectable elements 231 and the one or more sensors 232 may swap or exchange positions.

In some embodiments, the one or more detectable elements 231 are optical markers (e.g., painted or printed markers; surface texture; shape features), and the one or more sensors 232 are cameras (e.g., optical sensors). In such cases, the one or more sensors 232 may scan for the optical markers and/or capture images of the optical markers. The one or more sensors 232 may generate the sensor signals that include the images of the optical markers, and the controller 290 may analyze the images of the optical markers to determine the distance 297 between the cutter bar assembly 210 and the reel 220. For example, the controller 290 may analyze the images to determine the size of the optical markers in the images, and the controller 290 may correlate the size of the optical markers in the images to the distance 297 (e.g., via a look-up table stored in the memory 292). As noted herein, the one or more detectable elements 231 and the one or more sensors 232 may swap or exchange positions.

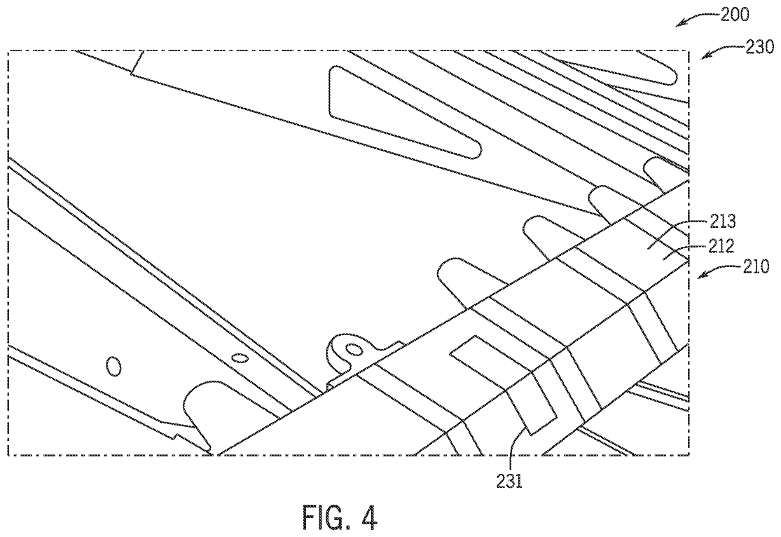

FIG. 4 is a perspective view of an embodiment of a portion of the header 200 and the sensor system 230, wherein the sensor system 230 includes an example of the detectable element 231 on the cutter bar assembly 210. As shown, the detectable element 231 is an optical marker or a surface feature (e.g., a reflector; recess) that is painted, printed, and/or formed on an upper surface 213 of the crop ramp 212 of the cutter bar assembly 210. However, as discussed herein, the detectable element 231 may be an emitter (e.g., an acoustic emitter or a light emitter) or an RFID tag, which may be supported on the upper surface 213 of the crop ramp 212 of the cutter bar assembly, positioned beneath a wall of the crop ramp 212 of the cutter bar assembly 210, or in another other suitable location of the cutter bar assembly 210.

As noted herein, the one or more detectable elements 231 and the one or more sensors 232 may swap or exchange positions as compared to FIGS. 2-4, such that the one or more detectable elements 231 are located on the reel 220 (e.g., on the reel bat 224 of the reel 220) and the one or more sensors 232 are located on the cutter bar assembly 210 (e.g., at the crop ramp 212 of the cutter bar assembly 210). However, the one or more sensors 232 located on the cutter bar assembly 210 may also be able to effectively and accurately detect the one or more detectable elements 231 on the tines 222 and/or other parts of the reel 220 that rotate with the central framework 223.

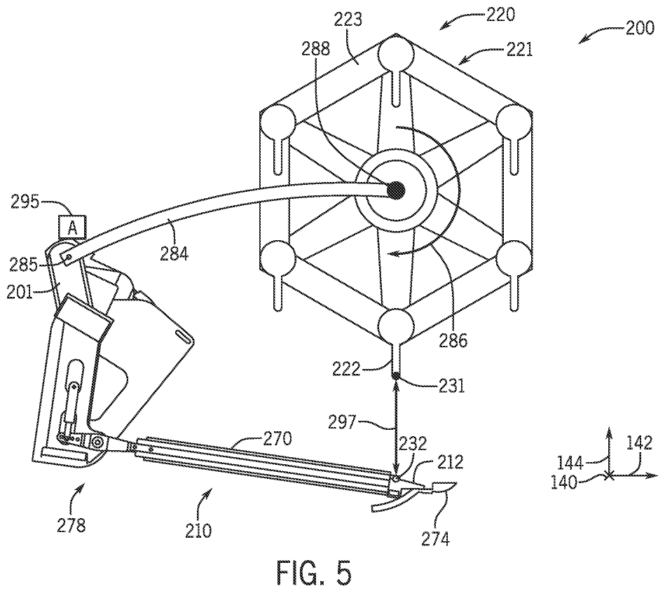

Accordingly, FIG. 5 is a cross-sectional side view of an embodiment of the header 200 and the sensor system 230 that may be employed within the agricultural system of FIG. 1, wherein the sensor system 230 is shown to include at least one detectable element 231 on at least one tine 222 of the reel 220. It should be appreciated that any of the components (e.g., the controller 290) and any of the operational features (e.g., calculating the distance 297; setting the boundary 400) shown and described herein with reference to FIG. 3 may be utilized in combination with the features shown and described herein with reference to FIG. 5.

When the one or more detectable elements 231 are on at least one tine 222 of the reel 220, the one or more detectable elements 231 may be an emitter, an optical marker, an RFID tag, or the like. However, when the one or more detectable elements 231 are on at least one tine 222 of the reel 220, it may be preferable for the one or more detectable elements 231 to be a passive element, such as an optical marker or a passive RFID tag (e.g., to avoid running cables for power and/or data to the tines 222).

In some embodiments, the one or more detectable elements 231 may include a metal object or component that is detectable by the one or more sensors 232. For example, with reference to FIG. 5, the one or more detectable elements 231 may include one or more metal pieces embedded in and/or coupled to at least one tine 222, such as at or near respective tips of the at least one tine 222. In some such cases, the one or more sensors 232 may be metal sensors that detect changes in a magnetic field due to changes in the relative position between the magnetic sensors and the metal pieces, which indicates the distance 297 between the reel 220 and the cutter bar assembly 210. Thus, the controller may process the sensor signals to determine the distance 297 between the reel 220 and the cutter bar assembly 210. It should be appreciated that the one or more detectable elements 231 may be any suitable metal object, such as an entire tine 222 formed from metal, a portion of the tine 222 formed from metal, and/or a portion of the central framework 223 formed from metal (e.g., the reel bat 224 formed from metal). As noted herein, the one or more detectable elements 231 and the one or more sensors 232 may swap or exchange positions, and thus, the one or more detectable elements 231 may be any suitable metal object or component on the cutter bar assembly 210 that is detectable by the one or more sensors 232 on the reel 220. Furthermore, the one or more detectable elements 231 may be magnets and the one or more sensors may be magnet sensors, which operate to detect the distance in a similar manner.

In some such cases, the one or more sensors 232 may be capacitance sensors that detect changes in capacitance due to changes in the relative position between the magnetic sensors and the metal pieces (or other conductive material), which indicates the distance 297 between the reel 220 and the cutter bar assembly 210. Thus, the controller may process the sensor signals to determine the distance 297 between the reel 220 and the cutter bar assembly 210. It should be appreciated that the one or more detectable elements 231 may be any suitable conductive object, such as an entire tine 222 formed from a conductive material, a portion of the tine 222 formed from the conductive material, and/or a portion of the central framework 223 formed from the conductive material (e.g., the reel bat 224 formed from the conductive material). As noted herein, the one or more detectable elements 231 and the one or more sensors 232 may swap or exchange positions, and thus, the one or more detectable elements 231 may be any suitable conductive material on the cutter bar assembly 210 that is detectable by the one or more sensors 232 on the reel 220.

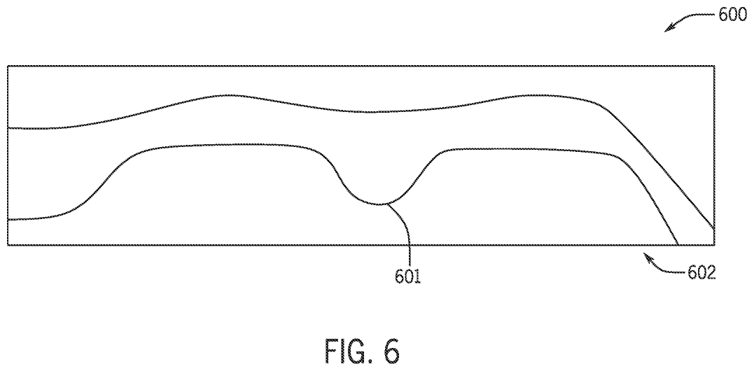

FIG. 6 is an example of a graph 600 that illustrates a skew 601 in a magnetic field 602 that may be detected by multiple sensors positioned across the width of the header. More particularly, as shown and described with reference to FIG. 2, the sensors may be positioned across the width of the header, and the detectable elements may be metal objects that are distributed across the width of the header 200. Thus, together the sensors may generate sensor signals indicative of the skew 601 in the magnetic field 602 across the width of the header 200, wherein the skew 601 in the magnetic field 602 is due to variations in the distance between the multiple sensors and the detectable elements across the width of the header 200. The controller may receive the sensor signals from the sensors and generate the graph 600, which may be utilized to determine whether any portion of the reel is in an undesirable position relative to the cutter bar assembly and/or to control the reel to avoid interference between the reel and the cutter bar assembly. In some embodiments, the graph 600 and/or similar information may be provided to an operator of the agricultural system, such as via a display screen associated with the agricultural system (e.g., in a cab of the agricultural system).

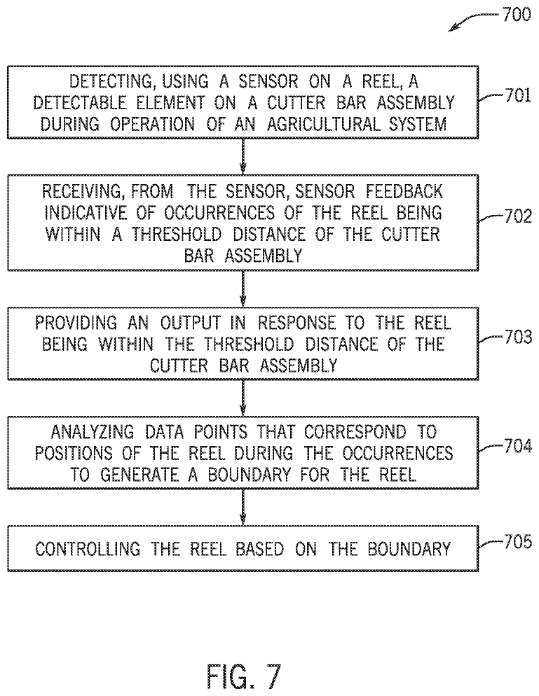

FIG. 7 is a flowchart of an embodiment of a method 700 for using a sensor system with a reel of a header. The flowchart includes various steps represented by blocks. Although the flowchart illustrates the steps in a certain sequence, it should be understood that the steps may be performed in any suitable order and certain steps may be carried out simultaneously, where appropriate. Further, certain steps may be omitted and/or other steps may be added. While certain steps are described as being performed by a controller, it should be understood that the steps or portions thereof may be performed by any suitable processing device.

In step 701, a sensor on a reel may detect a detectable element on a cutter bar assembly during operation of an agricultural system. Alternatively, the sensor may be positioned on the cutter bar assembly to detect the detectable element on the reel. In step 702, a controller may receive, from the sensor, sensor feedback indicative of occurrences of the reel being within a threshold distance of the cutter bar assembly.

In step 703, the controller may provide an output in response to the reel being within the threshold distance of the cutter bar assembly. For example, the controller may control one or more actuators to move the reel or a portion of the reel (e.g., to pivot the reel or the tines of the reel in the first direction away from the cutter bar assembly) and/or to provide other outputs. In step 704, the controller may analyze data points that correspond to positions of the reel during the occurrences to generate and/or to update a boundary for the reel. For example, each data point may represent the position of the reel (e.g., along the up/down axis and the fore/aft axis) at a respective occurrence of the tine body being within the threshold distance of the cutter bar assembly. The controller may raise the boundary at a particular location along the fore/aft axis in response to the sensor signals indicating one or more occurrences of the reel being within the threshold distance of the cutter bar assembly while the reel is at the particular location along the fore/aft axis.

In step 705, the controller may control the reel based on the boundary. For example, the controller may block downward movement of the reel across the boundary and/or slow downward movement of the reel below the boundary during harvesting operations. Additionally or alternatively, the controller may provide an alert via a display screen to notify the operator that an instructed command for the reel would cause the reel to move across the boundary. Thus, as set forth in the method 700, the controller may provide outputs based on the sensor feedback indicating that the reel is within the threshold distance of the boundary (step 701), set a boundary for the reel based on the sensor feedback (steps 702 and 703), and/or control the reel based on the boundary (step 704).

It should be appreciated that the sensor system may be utilized to generate and/or to update one or more boundaries for the reel; however, the sensor system may also be utilized merely to enable the controller to react to instances in which the reel is in an undesirable position relative to the cutter bar assembly (e.g., within the threshold distance; without being processed to establish any boundaries for the reel). Furthermore, variations in the sensor system are envisioned (e.g., the sensor on the cutter bar assembly and the detectable element on the reel, including the central framework of the reel and/or the tine of the reel). While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A sensor system for an agricultural machine, the sensor system comprising:
one or more first elements configured to be supported by a reel member that is configured to rotate relative to a frame of the agricultural machine;
one or more second elements configured to be supported by the frame of the agricultural machine, wherein the one or more first elements and the one or more second elements are configured to interact to generate sensor feedback; and
a controller configured to:
receive the sensor feedback;
analyze the sensor feedback to identify occurrences of the reel member being in an undesirable position relative to the frame of the agricultural machine; and
provide an output in response to the reel member being in the undesirable position relative to the frame of the agricultural machine.

2. The sensor system of claim 1, wherein the one or more first elements are supported by the reel member such that the one or more first elements rotate with the reel member relative to the frame of the agricultural machine.

3. The sensor system of claim 1, wherein the one or more first elements or the one or more second elements comprise one or more sensors.

4. The sensor system of claim 3, wherein the one or more sensors comprise one or more acoustic sensors, one or more optical sensors, one or more radiofrequency identification readers, one or more magnetic sensors, one or more capacitance sensors, or any combination thereof.

5. The sensor system of claim 1, wherein the one or more first elements or the one or more second elements comprise one or more detectable elements, and the one or more detectable elements comprise one or more acoustic emitters, one or more light emitters, one or more radiofrequency identification tags, one or more optical markers, one or more metal objects, or any combination thereof.

6. The sensor system of claim 1, wherein the one or more second elements comprise one or more magnetic sensors.

7. The sensor system of claim 6, wherein the one or more first elements comprise one or more metal objects.

8. The sensor system of claim 1, wherein the controller is configured to:
analyze the sensor feedback to calculate a distance between the reel member and the frame of the agricultural machine based on the sensor feedback;
compare the distance to a threshold distance; and
determine that the reel member is in the undesirable position relative to the frame in response to the distance being less than or equal to the threshold distance to thereby identify the occurrences of the reel member being in the undesirable position relative to the frame of the agricultural machine.

9. The sensor system of claim 1, wherein the output comprises controlling one or more actuators to move at least a portion of the reel member away from the frame of the agricultural machine.

10. The sensor system of claim 1, wherein the agricultural machine comprises an agricultural header.

11. The sensor system of claim 10, wherein the one or more second elements are supported by a cutter bar assembly of the frame of the agricultural header.

12. An agricultural machine, comprising:
a frame;
a reel member comprising a central framework and a plurality of tines coupled to the central framework; and
one or more sensors disposed on the frame or the reel member, wherein the one or more sensors are configured to detect one or more detectable elements disposed on the agricultural machine and to generate sensor feedback indicative of occurrences of the reel member being in an undesirable position relative to the frame.

13. The agricultural machine of claim 12, wherein the one or more sensors comprise one or more acoustic sensors, one or more optical sensors, one or more radiofrequency identification readers, one or more magnetic sensors, one or more capacitance sensors, or any combination thereof.

14. The agricultural machine of claim 12, wherein the one or more detectable elements comprise one or more acoustic emitters, one or more light emitters, one or more radiofrequency identification tags, one or more optical markers, one or more metal objects, or any combination thereof.

15. The agricultural machine of claim 12, wherein the one or more sensors comprise one or more magnetic sensors disposed on the frame, and the one or more detectable elements comprise a metal portion of the reel member.

16. The agricultural machine of claim 12, comprising a controller configured to:
receive the sensor feedback; and
control one or more actuators to move at least a portion of the reel member away from the frame in response to the reel member being in the undesirable position relative to the frame.

17. The agricultural machine of claim 12, comprising a controller configured to:
generate a boundary for the reel member based on the occurrences of the reel member being in the undesirable position relative to the frame; and
block the reel member from traveling across the boundary toward the frame.

18. The agricultural machine of claim 12, comprising one or more actuators that are configured to drive the reel member to move up and down relative to the frame, fore and aft relative to the frame, or both.

19. The agricultural machine of claim 12, wherein the agricultural machine comprises an agricultural header.

20. A method of operating an agricultural machine, the method comprising:
detecting, using one or more sensors, a detectable element disposed on a reel member or a frame of the agricultural machine;
receiving, at a controller, sensor feedback from the one or more sensors, wherein the sensor feedback is indicative of occurrences of the reel member being in an undesirable position relative to the frame of the agricultural machine; and
controlling, using the controller, one or more actuators to move at least a portion of the reel member away from the frame of the agricultural machine in response to the reel member being in the undesirable position relative to the frame of the agricultural machine.
